(19) United States
(12) Patent Application Publication
(10) Pub. No.: US 2021/0063790 A1
(43) Pub. Date: Mar. 4, 2021

(54) LIQUID CRYSTAL PANEL, MANUFACTURING METHOD THEREFOR AND APPLICATION THEREOF

(71) Applicant: SHENZHEN TCL NEW TECHNOLOGY CO., LTD., Shenzhen (CN)

(72) Inventor: Zhihui LI, Shenzhen (CN)

(21) Appl. No.: 16/960,511

(22) PCT Filed: Jul. 22, 2019
(86) PCT No.: PCT/CN2019/096985

§ 371 Date: Jul. 7, 2020

(30) Foreign Application Priority Data
Aug. 1, 2018 (CN) 201810865928.4

(51) Int. Cl. G02F 1/1339; G02F 1/1335; G02F 1/1337

(52) U.S. Cl. CPC G02F 1/1339; G02F 1/133512; G02F 1/1337; G02F 1/133528; G02F 1/133514

(57) ABSTRACT

A liquid crystal panel, a manufacturing method therefor and an application thereof. The liquid crystal panel comprises a first glass substrate (10), a second glass substrate (20), a liquid crystal layer (30), and a frame sealant (40). The frame sealant (40) is provided at the periphery of the liquid crystal layer (30) and used for sealing and assembling the first glass substrate (10) and the second glass substrate (20). The liquid crystal layer (30) is packaged between the assembled first glass substrate (10) and the second glass substrate (20). A circle of press (50) protruding toward the second glass substrate (20) is provided around the edge of the first glass substrate (10). A groove (60) for receiving the press (50) is formed on the second glass substrate (20). A gap between the groove (60) and the press (50) is filled with a screen sealant (70). The screen sealant (70) and the frame sealant (40) are prepared simultaneously, so as to solve the problem in the prior art of easy leakage of liquid crystals in the liquid crystal panel.

### TECHNICAL FIELD

The present disclosure relates to the field of liquid crystal display technology, and more particularly, to a liquid crystal panel, a manufacturing method therefor and an application thereof.

### BACKGROUND OF THE ART

A TFT-LCD is currently a most widely used display panel, having a mature technology and a low cost. However, in a real practice, a problem of leakage often occurs. In short, a liquid crystal panel is sandwiching liquid crystal between two pieces of glass, and the two pieces of glass are sealed together by a sealant, thus the sealant plays a role of fixing glass into a box and preventing a leakage of the liquid crystal. However, the sealant itself has a certain permeability for moisture, and currently a non-display area of a liquid crystal panel is getting smaller and smaller, which causes a width of the sealant narrower and narrower, making the liquid crystal panel often appear a case that water vapor corrodes the sealant and the liquid crystal leaks out in a real practice.

Currently, a method to deal with a liquid crystal leakage is adding a sealing process after a cell process, that is, adding one more layer of a sealing adhesive to a plurality of outer edges of the glass, to reduce a risk of leakage caused by water vapor invading the sealant (shown as FIG. 1). The method adds a sealing process in addition, which has reduced a production efficiency, and a plurality of problems often occur including colliding and peeling off the sealing adhesive during a plurality of processes including transporting the liquid crystal panel and assembling into a whole machine.

Therefore, the current technology needs to be improved and developed.

### BRIEF SUMMARY OF THE DISCLOSURE

According to the above described defects, the purpose of the present disclosure is providing a liquid crystal panel, a manufacturing method therefor and an application thereof, in order to solve a problem in the prior art that the liquid crystal in the liquid crystal panel is easy to leak out.

A technical solution of the present disclosure to solve the technical problems is as follows:

A liquid crystal panel, wherein comprising a first glass substrate, a second glass substrate, a liquid crystal layer, and a sealant, the sealant is arranged on a periphery of the liquid crystal layer and applied to sealing the first glass substrate and the second glass substrate before forming a box, the liquid crystal layer is packaged between the first glass substrate and the second glass substrate in the box formed; surrounding an edge of the first glass substrate, there is a circle of pressing body protruding toward the second glass substrate arranged, while the second glass substrate has a groove body for accommodating the pressing body arranged, a gap between the groove body and the pressing body has a sealing adhesive filled, the sealing adhesive and the sealant are prepared and formed at a same time.

The liquid crystal panel, wherein the pressing body is arranged between an edge of the first glass substrate and a periphery of the sealant.

The liquid crystal panel, wherein the groove body is formed by two closed annular protrusions sheathing together, and a height of the annular protrusion close to an edge of the second glass substrate is less than a height of the annular protrusion close to the sealant.

The liquid crystal panel, wherein the groove body is formed by two closed annular protrusions having a same shape but different sizes sheathing together in and out.

The liquid crystal panel, wherein an end of the pressing body has a plurality of openings arranged.

The liquid crystal panel, wherein the opening is arranged along an inner side of the groove body toward an outer side of the groove body.

The liquid crystal panel, wherein the pressing body is close to the inner side of the groove body when being accommodated into the groove body.

The liquid crystal panel, wherein a height of the groove body is larger than or equal to a height of the pressing body.

The liquid crystal panel, wherein the sealant has a plurality of silicon balls doped for a supporting function.

The liquid crystal panel, wherein a height of the silicon ball is greater than or equal to the height of the groove body.

The liquid crystal panel, wherein the pressing body is stacked by one or more layers of a black matrix, a colored photoresist, a gap photoresist, a metal layer, and an insulation layer, the groove body is stacked by one or more layers of a black matrix, a colored photoresist, a gap photoresist, a metal layer, and an insulation layer.

The liquid crystal panel, wherein further comprising a colored filter and an alignment layer arranged between the first glass substrate, the liquid crystal layer and the second glass substrate, and a polarizing plate arranged on an outer side of the first glass substrate and an outer side of the second glass substrate.

A manufacturing method for the liquid crystal panel described above, wherein comprising a plurality of steps:

producing the sealant on the second glass substrate for packaging the liquid crystal, and spraying the sealing adhesive into the groove body;

packaging the liquid crystal in a region defined by the sealant, then pressing the first glass substrate onto the second glass substrate, making the pressing body insert into the sealant, an excess sealing adhesive in the groove body overflows, and after curing, the liquid crystal panel is obtained.

The manufacturing method for the liquid crystal panel, wherein a spray amount of the sealing adhesive=an inner volume of the groove body−a volume of the pressing body+an overflow amount of the sealing adhesive.

An application of the liquid crystal panel described above, wherein the liquid crystal panel is applied in a cell phone, a computer, a tablet, or a television.

Benefits: The liquid crystal panels provided in the present disclosure, by arranging a pressing body and a groove body respectively at the edges of the glass substrates surrounding both sides of the liquid crystal panel, the groove body accommodates the pressing body, and a gap between the groove body and the pressing body is filled with the sealing adhesive, that has not only packaged the sealant by the sealing adhesive, preventing from being corroded by the water vapor, and avoiding the problem of the liquid leakage, but also because of arranging the pressing body and the groove body, the sealing adhesive may be firmly fitted between the edges of the grass substrates on both sides of the liquid crystal panel and the sealant, instead of being easily knocked off, and a problem that the sealant is corroded by the water vapor before causing the liquid crystal to leak out has also been avoided. The liquid crystal panel is easy to assemble and transport, while a problem in the prior art that the liquid crystal in a liquid crystal panel is easy to leak out has been solved.

### BRIEF DESCRIPTION OF THE DRAWINGS

FIG. 1 illustrates a schematic structural diagram of a liquid crystal panel manufactured by a conventional sealing process

FIG. 2 illustrates a schematic structural diagram of a liquid crystal panel according to an embodiment in the present disclosure.

FIG. 3 illustrates a schematic structural diagram of a side of a first glass substrate of a liquid crystal panel according to an embodiment in the present disclosure.

FIG. 4 illustrates a schematic structural diagram of a side of a second glass substrate of a liquid crystal panel according to an embodiment in the present disclosure.

FIG. 5 illustrates a schematic diagram of a manufacturing process of a liquid crystal panel according to an embodiment in the present disclosure.

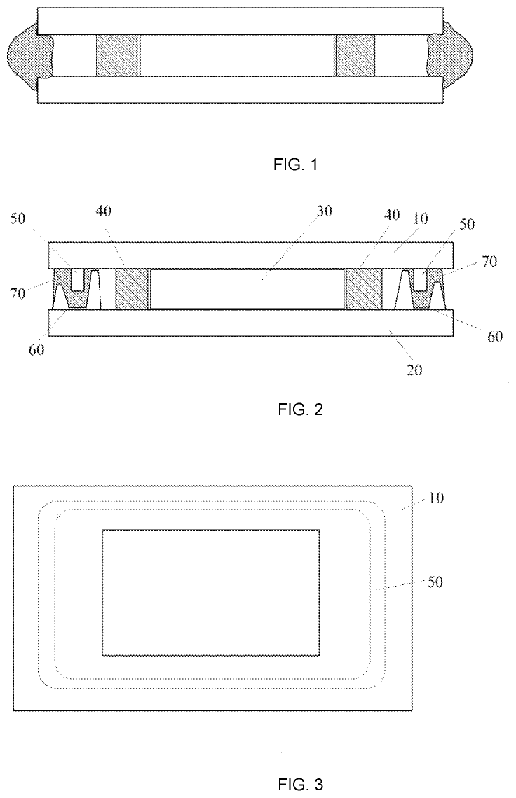

### DETAILED DESCRIPTION OF EMBODIMENTS

In order to make the purpose, technical solution and the advantages of the present disclosure clearer and more explicit, further detailed descriptions of the present disclosure are stated herein. It should be understood that the detailed embodiments of the disclosure described here are used to explain the present disclosure only, instead of limiting the present disclosure.

The present disclosure provides a liquid crystal panel, shown as FIGS. 2 to 4, comprising: a first glass substrate 10, a second glass substrate 20, a liquid crystal layer 30, and a sealant 40, the sealant 40 is arranged near an edge of the first glass substrate 10 and the second glass substrate 20, applied to sealing the first glass substrate 10, the second glass substrate 20, and the liquid crystal layer 30 between the first glass substrate 10 and the second glass substrate 20 into a cell, surrounding the edge of the first glass substrate 10 (outside the sealant 40), there is a circle of pressing body 50 protruding toward the second glass substrate 20, and the second glass substrate 20 has a groove body 60 arranged for accommodating the pressing body 50, that is, the groove body 60 is arranged surrounding the edge of the second glass substrate 20 and corresponding to the pressing body 50, a gap between the groove body 60 and the pressing body 50 has a sealing adhesive 70 filled, the sealing adhesive 70 and the sealant 40 are prepared and formed at a same time.

Obviously, in a plurality of embodiments, in order to realize a function of liquid crystal displaying, between the first glass substrate 10, the liquid crystal layer 30 and the second glass substrate 20, there are a plurality of other functional layers arranged, including a colored filter, an alignment layer and more, as well as a plurality of polarizing plates arranged on an outer side of the first glass substrate 10 and the second glass substrate 20.

In the present disclosure, by the sealant 40, the liquid crystal layer 30, the first glass substrate 10 and the second glass substrate 20 are fixed into a cell, while the sealant 40 forms an internal barrier to prevent a liquid crystal leakage; the sealing adhesive 70 is filled in the gap between the groove body 60 and the pressing body 50, while the groove body 60 and the pressing body 50 are arranged respectively between edges of two glass substrates and the sealant 40, that is, by a combination of the groove body 60, the pressing body 50 and the sealing adhesive 70, the sealant 40 is packaged in the two glass substrates, providing a sealing and a protection to the sealant 40, preventing the sealant 40 from being corroded by water vapor, and forming an external barrier to prevent the liquid crystal leakage. In addition, since the pressing body 50 is accommodated by the groove body 60, while the sealing adhesive 70 is filled in a gap between two of them, thus a presence of the pressing body 50 and the groove 60 may form a snap action onto the sealing adhesive 70 before firmly fixing the sealing adhesive 70 from being easily fallen off. A plurality of problems in the prior art have been solved, including the sealing adhesive gets fallen off after being collided during a process of shipping the liquid crystal panel and assembling into a whole machine, caused by simply adding a sealing adhesive to an outer edge of a glass. In addition, in the present disclosure, both the sealing adhesive 70 and the sealant 40 are prepared and formed at a same time, while preparing the sealant 40 is an existing process when manufacturing the liquid crystal panel, therefore, the present disclosure will not increase a production process of the sealing adhesive 70.

In the liquid crystal panel, the sealant 40 is arranged between two glass substrates surrounding the liquid crystal layer 30, in order to fully realize a sealing and protection to the sealant 40, the pressing body 50 in the present disclosure is also arranged surrounding the edge of the first glass substrate 10, that is, in some embodiments, the pressing body 50 is also arranged between the edge of the first glass substrate 10 and an outer periphery of the sealant 40 (shown as FIG. 3), showing as a closed structure in a whole.

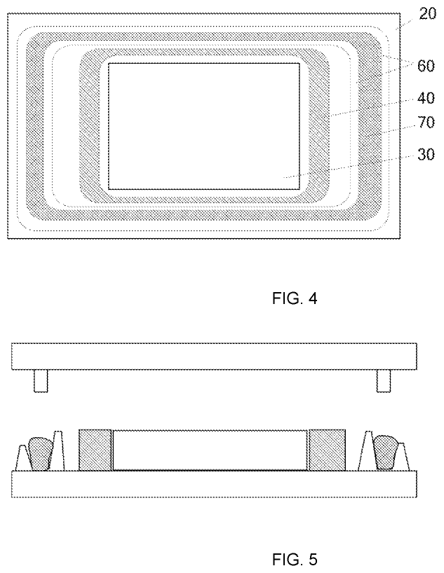

In some embodiments, the groove body 60 is formed by two closed annular protrusions sheathing together in and out, and there is a gap between the two closed annular protrusions, the gap is a space for accommodating the pressing body 50, making the groove body 60 shown as an uninterrupted ring structure in a whole (as shown in FIG. 4), that is, the groove body 60 comprises an inner closed annular protrusion and an outer closed annular protrusion sleeved outside the inner closed annular protrusion, and a height of the outer closed annular protrusion is smaller than a height of the inner closed annular protrusion, that is, the groove body 60 is arranged with a height of one side close to the edge of the second glass substrate 20 smaller than a height of one side close to the sealant 40, in such a way, after finishing pairing two glass substrates, a sealing adhesive squeeze-out opening will be left between an outside of the groove body 60 and the first glass substrate 10, making any excess sealing adhesive filled in the groove body 60 in advance prefer to flow out to the outside, instead of overflowing to the inside, to avoid contaminating an internal area of the liquid crystal display. In some embodiments, the groove body 60 is formed by two closed annular protrusions having a same shape but different sizes sheathing together in and out.

In some embodiments, an end of the pressing body 50 has a plurality of openings arranged. In some embodiments, the openings are arranged laterally at a bottom of the pressing body 50, along a direction from an inner side of the groove body 60 toward an outer side, such an arrangement of the openings facilitates the sealing adhesive 70 on an inner side of the pressing body to flow out to the outside through the openings on the pressing body 50.

In some embodiments, for the liquid crystal panel, the pressing body 50 is aligned close to the inner side of the groove body 60 when being accommodated into the groove body 60, to reduce an overflow amount of the sealing adhesive flowing to the inner side, and prevent the sealing adhesive from overflowing too much to the inner side of the groove body 60 and contaminating the internal area of the liquid crystal display, while at a same time, no sealing effect of the sealing adhesive 70 will be affected.

In some embodiments, for the liquid crystal panel, the sealant 40 has a plurality of silicon balls for a supporting function doped; In some embodiments, a height of the silicon ball is greater than or equal to a height of the groove body 60. Although a function of the sealant 40 is sealing the two glass substrates together and packaging the liquid crystal inside, a space for the liquid crystal must be left, thus it is needed to ensure a certain gap between the first glass substrate 10 and the second glass substrate 20, thus it is needed to dope the silicon balls in the sealant 40 for the supporting function, to prevent the first glass substrate 10 and the second glass substrate 20 from fitting too close and affecting the liquid crystal layer; while setting the height of the silicon ball greater than or equal to the height of the groove body, the silicon ball may play an inherent supporting role thereof, being able to ensure that the gap between the two glass substrates is uniform, and eventually a TFT-LCD will not display poorly; in some embodiments, due to an accommodation function of the groove body 60 to the pressing body 50 shall be achieved, the height of the groove body 60 should be greater than or equal to the height of the pressing body 50.

Manufacturing the pressing body 50 and the groove body 60 of the liquid crystal panel needs no extra materials or extra processes. In some embodiments, the pressing body 50 is stacked by one or more layers of a black matrix, a color photoresist, a gap photoresist, a metal layer, and an insulation layer, the groove body 60 may also be stacked by one or more layers of a black matrix, a color photoresist, a gap photoresist, a metal layer, and an insulation layer.

The present disclosure further provides a manufacturing method for the liquid crystal panel, wherein comprising a plurality of steps:

S1. producing the sealant on the second glass substrate for sealing the liquid crystal, and spraying the sealing adhesive into the groove body;

S2. sealing the liquid crystal in a region defined by the sealant, then pressing the first glass substrate onto the second glass substrate, making the pressing body insert into the sealant, an excess sealing adhesive in the groove body overflows, and after curing, the liquid crystal panel is obtained.

In some embodiments, in the step S1, a spray amount of the sealing adhesive equals to an inner volume of the groove body minus a volume of the pressing body plus an overflow amount of the sealing adhesive, that is, the spray amount of the sealing adhesive=an inner volume of the groove body−a volume of the pressing body+an overflow amount of the sealing adhesive, so as to achieve that when sealing the edges of the sealant with the sealing adhesive, the sealing adhesive will not overflow out of the liquid crystal panel.

In some embodiments, in the step S2, by pressing the first glass substrate onto the second glass substrate, making the pressing body insert into the sealant, that is, achieving accommodating the pressing body into the groove body, thus under an action of the sealant and an action of the accommodation of the pressing body and the groove body, the first glass substrate is located and fixed onto the second glass substrate, an excess sealing adhesive in the groove body overflows, and curing, a process of the curing comprises a thermal curing and a UV curing, so as to cure both the sealant and the sealing adhesive.

In the prior arts, a sealing screen and manufacturing process of the liquid crystal panel responding to a liquid leakage comprises a sealant coating, an assembly alignment, a thermal curing, a primary UV light curing, a sealing adhesive coating, and a secondary UV light curing. While in the embodiments provided by the present disclosure, since the groove body and the pressing body are both prepared in advance, performing a cell forming process after the two glass substrates are manufactured, and the sealing adhesive is coated inside the groove body, shown as FIG. 5, both the sealant and the sealing adhesive may be synchronized with two nozzles at a same time, which may reduce a manufacturing time and improve a production efficiency. When the pressing body is inserted into the groove body, the pressing body will squeeze the sealing adhesive out of the groove body. Since the outside of the groove body is lower than the inner side thereof, the sealing adhesive will flow along the outside of the groove body, a final effect is shown as FIG. 2. After assembling, a heat curing and a UV curing are performed. Since manufacturing the sealant itself has already required a UV irradiation, thus a curing process of the sealing adhesive can be completed simultaneously without any additional steps. Compared with the sealing screen and manufacturing process of the liquid crystal panel in the prior art, a separate UV curing process for the sealing adhesive is omitted.

The present disclosure can realize the coating and curing of the sealing adhesive without adding any new materials or new processes, simplifying an original process. Also a design of the groove body has also increased an ability of preventing the water vapor from intrusion thus enhanced a reliability of the liquid crystal panel.

The embodiments provided in the present disclosure further provides an application of the liquid crystal panel described above, wherein the liquid crystal panel is applied in a cell phone, a computer, a tablet, or a television.

All above, the liquid crystal panels provided in the embodiments of the present disclosure, by arranging a pressing body and a groove body respectively at the edges of the glass substrates surrounding both sides of the liquid crystal panel, the groove body accommodates the pressing body, and a gap between the groove body and the pressing body is filled with the sealing adhesive, that has not only sealed the sealant by the sealing adhesive, preventing from being corroded by the water vapor, and avoiding the problem of the liquid leakage, but also because of arranging the pressure body and the groove body, the sealing adhesive may be firmly fitted between the edges of the grass substrates on both sides of the liquid crystal panel and the sealant, instead of being easily knocked off, and a problem that the sealant is corroded by the water vapor before causing the liquid crystal to leak out has also been avoided. The liquid crystal panel is easy to assemble and transport, while a problem in the prior art that the liquid crystal in a liquid crystal panel is easy to leak out has been solved.

It should be understood that, the application of the present invention is not limited to the above examples listed. Those skilled in the art can improve or change the applications according to the above descriptions, all of these improvements and transforms should belong to the scope of protection in the appended claims of the present invention.

1. A liquid crystal panel, wherein comprising a first glass substrate, a second glass substrate, a liquid crystal layer sealed between the first glass substrate and the second glass substrate, and a sealant arranged to seal the first glass substrate and the second glass substrate into a cell, surrounding an edge of the first glass substrate, there is a circle of pressing body protruding toward the second glass substrate arranged, while the second glass substrate has a groove body for accommodating the pressing body arranged, a gap between the groove body and the pressing body has a sealing adhesive filled, the sealing adhesive and the sealant are prepared and formed at a same time.

2. The liquid crystal panel according to claim 1, wherein the pressing body is arranged between an edge of the first glass substrate and a periphery of the sealant.

3. The liquid crystal panel according to claim 1, wherein the groove body is formed by two closed annular protrusions sheathing together, and a height of the annular protrusion close to an edge of the second glass substrate is less than a height of the annular protrusion close to the sealant.

4. The liquid crystal panel according to claim 3, wherein the groove body is formed by two closed annular protrusions having a same shape but different sizes sheathing together in and out.

5. The liquid crystal panel according to claim 1, wherein an end of the pressing body has a plurality of openings arranged.

6. The liquid crystal panel according to claim 5, wherein the opening is arranged along an inner side of the groove body toward an outer side of the groove body.

7. The liquid crystal panel according to claim 3, wherein the pressing body is close to the inner side of the groove body when being accommodated into the groove body.

8. The liquid crystal panel according to claim 1, wherein a height of the groove body is larger than or equal to a height of the pressing body.

9. The liquid crystal panel according to claim 1, wherein the sealant has a plurality of silicon balls doped for a supporting function.

10. The liquid crystal panel according to claim 9, wherein a height of the silicon ball is greater than or equal to the height of the groove body.

11. The liquid crystal panel according to claim 5, wherein the pressing body is stacked by one or more layers of a black matrix, a colored photoresist, a gap photoresist, a metal layer, and an insulation layer, the groove body is stacked by one or more layers of a black matrix, a colored photoresist, a gap photoresist, a metal layer, and an insulation layer.

12. The liquid crystal panel according to claim 1, wherein further comprising a colored filter and an alignment layer arranged between the first glass substrate, the liquid crystal layer and the second glass substrate, and a polarizing plate arranged on an outer side of the first glass substrate and an outer side of the second glass substrate.

13. A manufacturing method for the liquid crystal panel according to claim 1, wherein comprising a plurality of steps:
producing the sealant on the second glass substrate for packaging the liquid crystal, and spraying the sealing adhesive into the groove body;
packaging the liquid crystal in a region defined by the sealant, then pressing the first glass substrate onto the second glass substrate, making the pressing body insert into the sealant, an excess sealing adhesive in the groove body overflows, and after curing, the liquid crystal panel is obtained.

14. The manufacturing method for the liquid crystal panel according to claim 13, wherein a spray amount of the sealing adhesive =an inner volume of the groove body−a volume of the pressing body+an overflow amount of the sealing adhesive.

15. An application of the liquid crystal panel according to claim 1, wherein the liquid crystal panel is applied in a cell phone, a computer, a tablet, or a television.
